(19) United States
(12) Patent Application Publication
(10) Pub. No.: US 2014/0234474 A1
(43) Pub. Date: Aug. 21, 2014

(54) DELIVERY SYSTEM FOR NUTRITIONAL ADDITIVES FOR WILDLIFE

(71) Applicant: Do All Outdoors, LLC, Nashville, TN (US)

(72) Inventors: Bruce BRUNNER, Minneapolis, MN (US); Casey WEISSER, Andover, KS (US)

(73) Assignee: Do All Outdoors, LLC, Nashville, TN (US)

(21) Appl. No.: 14/186,458

(22) Filed: Feb. 21, 2014

Related U.S. Application Data
(60) Provisional application No. 61/767,549, filed on Feb. 21, 2013.

(51) Int. Cl. A01K 5/015; A01K 29/00; A01K 7/00; A23K 1/16

(52) U.S. Cl. CPC A01K 5/015; A23K 1/16; A01K 29/00; A01K 7/00
USPC 426/2; 426/66

(57) ABSTRACT

The invention provides methods of administering one or more supplements to an animal in a liquid solution, comprising providing a non-naturally occurring water source, containing an effective amount of one or more supplements, and locating the water source in the animal's environment, such that when the animal consumes water from the water source, the supplements are consumed by the animal. The supplement can be formulated as a concentrate additive.

This application claims the benefit under 35 U.S.C. 119 (e) of U.S. Provisional Application No. 61/767,549, filed Feb. 21, 2013.

### BACKGROUND OF THE INVENTION

The use of feed for promoting the health and growth of wildlife is well established.

Hunters, naturalists, researchers, conservationists, and others concerned with the health and well-being of wildlife regularly provide feed to animals, particularly large game animals, such as ungulates.

Natural environments are continually changing, due to climate changes, pollution, invasive species, development and loss of natural areas, and so new products and new approaches for enhancing the health, well-being and growth of wildlife are continually needed.

### SUMMARY

The present invention provides methods and systems for providing nutrients, additives, minerals and supplements to wildlife or a population of wildlife via water delivery system or non-naturally occurring water source that is utilized by wildlife, whether through convenience, necessity or preference. The non-naturally occurring water sources can consist of any vessel for holding water in an outdoor environment, including but not limited to a simple bucket, water trough or constructed water source similar to that of a feeder or agriculture tank.

An embodiment of the invention is a method of administering one or more supplements to an animal, comprising providing a source of drinking water, containing an effective amount of one or more supplements, and locating the non-naturally occurring water source in said animal's environment, such that when said animal consumes water from the water source, the supplements are consumed by said animal.

In some embodiments of the methods of the invention, the animal is a wild animal, an undomesticated animal, including those that roam freely in a natural environment or as part of a natural ecosystem. In other embodiments of the methods of the invention, the wild animal is an ungulate. In certain embodiments of the methods of the invention, the ungulate is a deer, elk or moose.

In other embodiments of the methods of the invention, the supplement is an attractant for the animal. In further embodiments of the methods of the invention, the attractant is apple, acorn, salt, or other attractant, or a combination thereof.

In another embodiment of the invention, the supplement is a nutritional supplement. In certain embodiments of the invention, the supplements optionally comprise a pharmaceutically or veterinary acceptable carrier. In other embodiments, the supplement is stock salt or trace minerals or a combination thereof. In other embodiments, the supplement is a nutritional supplement, vitamin, amino acid, enzyme, protein source, stock salt, trace mineral or any other composition, element, or compound that is beneficial to the health or development of the animal, or a combination thereof.

In yet another embodiment of the invention, the consumption of the supplement enhances the health of the animal. In still other embodiments, the antler development of an ungulate is enhanced due to the consumption of the supplement in the non-naturally occurring water source. In another embodiment s of the invention, the consumption of the supplement by the ungulate causes the size of the antlers of said ungulate to increase, as compared to the size of the antlers of an ungulate not consuming the supplement in the drinking water in the non-naturally occurring water source.

Another embodiment of the invention is a method of providing one or more supplements to an animal, comprising providing a water reservoir in the animal's environment, wherein the reservoir is a non-naturally occurring source of water, and wherein the reservoir contains an amount of one or more concentrated supplements and an amount of water, such that when the animal drinks from the reservoir, an effective amount of the supplement is consumed by the animal.

Provided in certain embodiments are methods of enhancing one or more traits of an animal in the wild, comprising providing a non-naturally occurring water source in a natural environment, where the water source contains water and an effective amount of a supplement, where the environment contains an animal, and wherein the animal drinks an amount of the contents of said water source, and the ingestion of the contents of the water source by the animal provides one or more traits of said animal to be enhanced, in comparison to an animal not drinking an amount of the contents of the water source. In an embodiment of the methods of the invention, the animal is a wild animal. In other embodiments, the wild animal is an ungulate, such as a deer, elk, caribou, reindeer or moose.

In other embodiments, the supplement is an attractant, a nutrient, a nutritional supplement, stock salts, or trace minerals, or a combination thereof. Additionally, in an embodiment of the methods of the invention, the trait that is enhanced is the antler size, including but not limited to an increased in the size of the antlers of an ungulate is increased, as compared to the size of the antlers of an ungulate not consuming the supplemented water in the water source.

Also provided are systems for increasing the intake of nutrients by an animal in the wild, comprising placing a non-naturally occurring water source in an environment, where the environment contains at least one animal, where said water source contains water and an effective amount of a beneficial nutrient for the animal, and where the animal is attracted to the water source, and where the animal consumes an amount of the contents of the water source, wherein by consuming the contents of the water source, the animal consumes an amount of a nutrient, as compared to an animal not consuming the contents of the water source.

In other embodiments of the systems provided herein, the nutrient is a protein. Also, the systems provided herein optionally may comprise an amount of stock salts, one or more trace minerals, vitamins, elements, or a combination thereof, or an amount of an attractant.

Additionally, in certain embodiments of the systems of the invention, the animal is an ungulate, including but not limited to a deer, elk, reindeer, caribou or moose.

Also provided are methods of enhancing the health of a wildlife animal population, comprising placing a non-naturally occurring water source in an environment, where the environment contains a population of animals, where said water source contains water and an effective amount of a supplement for the animals, where the animals are attracted to the water source, and wherein the animals consume an amount of the contents of the water source, where by consuming the contents of the water source, the animals consume an effective amount of a supplement, which enhances the health of the animal population, as compared to an animal not consuming the contents of the water source.

In certain embodiments of the methods, the supplement is one or more proteins, vitamins, trace elements, trace minerals, salts, sugars, enzymes, pharmaceuticals, additives, attractants, amino acids, vaccines, anti-oxidants, DNA, RNA, neutraceuticals, medicaments, or a combination thereof.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 is a photograph of two deer at a non-naturally occurring water source. The photograph is taken in an outdoor environment.

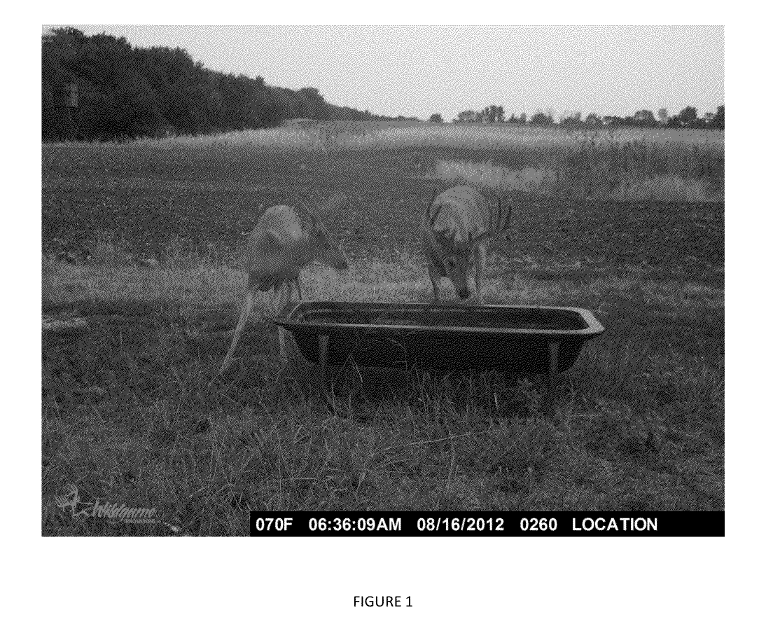

### DETAILED DESCRIPTION

Land managers, environmental scientists, and wildlife professionals continue to look for new methods to improve the overall health and well-being of wildlife populations, including but not limited to, ungulate populations. Hunters and outdoor enthusiasts are continually seeking ways to improve game animal growth and health. Land managers are continuing to seek ways to improve the overall health of ungulate wildlife populations and hunters are seeking ways to improve antler growth and attraction to increase their odds of success.

As a non-limiting example, increased ungulate antler growth is desired by many of those who hunt for sport. In addition, both wildlife professionals and hunters continue to search out systems and methods for attracting wildlife to certain areas. In some cases, the ability to regularly attract an animal or a group of animals to a certain area increases the odds of success for a game hunter, and for a researcher or conservationist, increases the likelihood of successful study of the animal or the animal population, or the likelihood of successful beneficial interventions in enhance the well-being of the animals in a population or region.

Many products are available for wildlife ungulate's nutrition and attraction. Food plot seed, mineral supplements, dietary elements, trace minerals, licks, feeds, attractants, and many more products have come into the market for land managers and wildlife managers to utilize or employ to improve the overall health of a wildlife population on their land. These products are typically in the form of powders, solids, and pellets, and have been formulated to take into account the ability of a wildlife animal to feed, eat, or lick a solid product, one that is mixed into forgeable materials on the ground, or simply placed on the ground by sprinkling or other means of distributing a solid food on the ground.

The present invention may be used to purely attract or lure wildlife to a particular area, or to hold an animal population to a particular area. The invention may also be used to provide a benefit to the wildlife, as the wildlife will have health and nutritional benefits due to the compositions and methods of the present invention.

By feeding animals at a stationary location over a period of time, the animals become accustomed to the presence of food, and will return to the area regularly for feeding. The regularity of the feeding allows for the individuals interested in the animals to locate study, observe, or follow the animals. For example, a hunter can choose a hunting position near the feeding area, thereby increasing the likelihood of a desirable game animal approaching within the effective range of the hunter's weapon. In another example, a forest ranger can track certain animal inhabitants of a given area to ascertain the health or size of a particular animal population.

The simplest method of feeding game animals is to periodically dispense the feed onto the ground by hand. Game animals have a strong sense of smell and are adverse to human scent. Therefore, it is generally undesirable for humans to return to the feeding area for food replenishment on a frequent basis. Also, food dispensed upon the ground may be eaten by animals other than the animals of interest, and thereby defeating the purpose of dispensing the feed. For these reasons, a broad range of feeders are available that can be set up and left unattended for a significant period of time before replenishment is necessary.

The methods and systems of the invention may be used to study a population of wildlife in a habitat. The methods and systems of the present invention may also be used to maintain the health of a population of wildlife, in general, as well as during times of stress. Times of stress for the population of wildlife may include, but are not limited to, drought, fire, natural disaster, disease outbreak, loss of natural or prior food sources, and competition for resources due to invasive species. As a non-limiting example, the methods and systems provided herein may be used to supply the nutrients or fluids required for maintaining the health of an animal population when the natural or regular sources of the nutrients or fluids are not available to the population for any reason.

The methods disclosed in certain embodiments may be used to increase the viability of the offspring of a wildlife population, or to decrease morbidity and/or mortality of a wildlife population. The methods disclosed in certain embodiments may also be used to provide hydration and fluids to a wildlife population during times of drought.

### Definitions

As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation.

The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values, e.g., weight percents, proximate to the recited range that are equivalent in terms of the functionality of the individual ingredient, the composition, or the embodiment.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

The term “contacting” refers to the act of touching, making contact, or of bringing to immediate or close proximity, including but not limited to, at the surface of mucous membranes, or in the oral cavity of an animal, or at the cellular or molecular level, for example, to bring about a physiological reaction, a chemical reaction, or a physical change, e.g., in a solution, in a reaction mixture, in vitro, or in vivo.

The term “ingesting” refers to the act of taking food or liquid into the body by mouth for digestion or absorption.

An “effective amount” refers to an amount effective to provide nutritional support, or to attract an animal to a given area or environment, or to treat a disease, disorder, and/or condition, or to bring about a recited effect. For example, an amount effective can be an amount effective to increase the growth of an animal's antlers, or to increase the growth of another area of an animal's body. Additionally, effective amount refers to an amount effective to reduce the progression or severity of the condition or symptoms being treated. Determination of a nutritionally or therapeutically effective amount, as well as an effective amount for attracting wildlife, is well within the capacity of persons skilled in the art, especially in light of the detailed disclosure provided herein. The term “effective amount” is intended to include an amount of a compound described herein, or an amount of a combination of compounds described herein, e.g., that is effective to nutritionally support an animal, or to attract an animal to a given area in the environment, or to treat or prevent a disease or disorder, or to treat the symptoms of the disease or disorder, in an animal. Thus, an “effective amount” generally means an amount that provides the desired effect.

The terms “treating”, “treat” and “treatment” include (i) preventing a disease, pathologic or medical condition from occurring (e.g., prophylaxis); (ii) inhibiting the disease, pathologic or medical condition or arresting its development; (iii) relieving the disease, pathologic or medical condition; and/or (iv) diminishing symptoms associated with the disease, pathologic or medical condition. Thus, the terms “treat”, “treatment”, and “treating” extend to prophylaxis and include prevent, prevention, preventing, lowering, stopping or reversing the progression or severity of the condition or symptoms being treated. As such, the term “treatment” includes veterinary, therapeutic, and/or prophylactic administration, as appropriate.

As used herein, the terms “trace minerals,” “trace elements,” “minor elements,” “dietary elements,” “mineral nutrients,” and “dietary minerals” are equivalent. Trace minerals are chemical elements required for the growth and development of living organisms. The list of trace minerals includes iron, copper, zinc, manganese, fluoride, selenium, copper and may optionally include other elements. Trace minerals, as used herein, can include one or more or all of the trace minerals listed above.

Major dietary elements required for the growth and development of living organisms include calcium, phosphorus, potassium, sulfur, sodium, chlorine and magnesium. Trace minerals and major dietary elements are commercially available and come in a variety of forms appropriate for use in the methods and systems of the invention. Such forms include, but are not limited to, powders, liquids, gels, solids, pellets, granules, tablets, pills, and the like.

As used herein, the phrase “stock salt” is sodium chloride in a form suitable for intake by an animal for veterinary, agricultural or wildlife management or hunting purposes. Stock salts are commercially available. The stock salt can be iodized or non-iodized, and optionally, may contain an amount of one or more trace elements or trace minerals or other additives.

As used herein, the terms “nutritional supplement,” “supplement,” and “additive” can be used interchangeable, and refer to elements, compositions and/or compounds for enhancing the diet of an animal. Supplements of the present invention include, but are not limited to, supplements for increasing, enhancing, or promoting the growth or the maintenance of bones, muscle, tissue, dermis, skin, fur, fat, antlers, vascular system, nervous system, lymphatic system, hematological system, respiratory system, gastrointestinal system, urinary and filtration systems, organs, reproductive systems, or appearance, in overall terms as well as in ways that increase, enhance or promote certain aspects or traits desired in an animal population, including but not limited to weight gain or weight control, or to promote health in a population with lactating animals.

Supplements of the present invention include, but are not limited to, those elements, compositions or compounds that provide beneficial nutritional or dietary additives to an animal population, as well as those elements, compositions and compounds that prevent or treat or inhibit certain conditions in an animal or animal population. Such supplements include, but are not limited to, vitamins, enzymes, salts, sugars, minerals, vaccines, amino acids, proteins, anti-oxidants, DNA, RNA, pharmaceuticals, neutraceuticals, veterinary compositions, trace minerals, major dietary elements, nutritional components, medicaments, and the like, as well as any suitable element, composition or compound to achieve the desired effect. Supplements for use in the invention are commonly commercially available, for example, at livestock, veterinary or wildlife or wild game supply companies.

The supplements and additives as used in the present invention may be formulated to improve reproduction, survival, or in utero productivity in a wildlife animal population, as well as provide improved health and survival rates, or improved or increased antler development, increased body growth and maturation, or increased population size and stability, in or of an animal population, as well as enhance herd management to maximize biological and economic returns. The supplements and additives of the present invention and as used in the methods and systems of the present invention may provide increased population health and stability, as well as decrease or reduce mortality, in an animal population during a nutritionally stressful season.

The supplements and additives of the present invention and as used in the methods and systems of the present invention may be used to attract an animal or a population of animals to a particular area, for any purpose, including but not limited to the purposes of herd management, research, or hunting.

The supplements and additives of the present invention and as used in the methods and systems of the present invention may also be attractants or used in combination with attractants. The attractants may be in the form of solid, liquid, granular, powder, or other suitable form.

The terms “inhibit”, “inhibiting”, and “inhibition” refer to the slowing, halting, or reversing the growth or progression of a disease, infection, condition, or group of cells. The inhibition can be greater than about 20%, 40%, 60%, 80%, 90%, 95%, or 99%, for example, compared to the growth or progression that occurs in the absence of the treatment or contacting.

The term “animal,” as used herein, refers to any of a kingdom of living things including, but not limited to a member of Kingdom Animalia, including many-celled organisms, and the single-celled organisms that typically differ from plants in 1) having cells without cellulose walls, 2) lacking chlorophyll and the capacity for photosynthesis, 3) requiring more complex food materials, for example, proteins, 4) being organized to a greater degree of complexity, and 5) having the capacity for spontaneous movement and rapid motor responses to stimulation. The term animal, as used herein, also refers to any of Kingdom Animalia grand divisions, or subkingdoms, and the principal classes under them, including, but not limited to: Vertebrata, including Mammalia or mammals, including Ayes or birds, Reptilia, Amphibia, Pisces or fishes, Marsipobranchiata (Craniota); and Leptocardia (Acrania). Tunicata, including the Thaliacea, and Ascidioidea or ascidians. Articulata or Annulosa, including Insecta, Myriapoda, Malacapoda, Arachnida, Pycnogonida, Merostomata, Crustacea (Arthropoda); and Annelida, Gehyrea (Anarthropoda). Helminthes or vermes, including Rotifera, Chaetognatha, Nematoidea, Acanthocephala, Nemertina, Turbellaria, Trematoda, Cestoidea, Mesozea. Molluscoidea, including Brachiopoda and Bryozoa. Mollusca, including Cephalopoda, Gastropoda, Pteropoda, Scaphopoda, Lamellibranchiata or Acephala. Echinodermata, including Holothurioidea, Echinoidea, Asterioidea, Ophiuroidea, and Crinoidea. Coelenterata, including Anthozoa or polyps, Ctenophora, and Hydrozoa or Acalephs, Spongiozoa or Porifera, including the sponges. Protozoa, including Infusoria and Rhizopoda. The term animal, as used herein, further refers to the following non-limiting examples: human, primate, ungulates, dog, cat, cow, lamb, pig, hog, poultry, horse, deer, moose, caribou, wolf, reindeer, mare, mule, jack, jenny, colt, calf, yearling, bull, ox, sheep, goat, llama, bison, buffalo, lamb, kid, shoat, hen, chicken, turkey, duck, goose, ostrich, other birds or fowl, rabbit, hare, guinea pig, hamster mouse, rat, other rodents, fish and other aquatic species, and amphibians. The term “animal” as used herein additionally refers to transgenic animals.

The term “ungulate” refers to animals of or belonging to the former order Ungulata, now divided into the orders Perissodactyla (those having an odd number of toes) and Artiodactyla (those having an even number of toes), and composed of the hoofed mammals. The term “ungulate” also refers to any of a large group of domesticated, feral, and non-domesticated animals of which all have hooves, including but not limited to, horses, rhinoceroses, pronghorn, sheep, moose, caribou, reindeer, elk, antelope, cattle, goats, tapirs, asses, donkeys, onagers, zebra, camels, llamas, tarpans, deer, swine, and elephants. Ungulates may or may not be hindgut fermenters or ruminants.

The terms “wildlife” and “wild animal,” as used herein, refer to non-domesticated animals or native fauna of a region, or living things that are neither human nor domesticated.

The phrase “game animal” or “game animals” refers to animals hunted for food, sport or profit, or those animals not normally domesticated. The type and range of animals hunted for food varies in different parts of the world, and is influenced by climate, animal diversity, local taste and locally accepted view about what can or cannot be legitimately hunted. Sometimes a distinction is also made between varieties and species of a particular animal, such as wild or domestic turkey (as a non-limiting example).

As used herein, the phrase “animal of interest” refers to the animal or animal population or populations to be treated or to be given the compositions of the present invention, or to the animal or animal population or populations to be subjected to the methods of the present invention.

The term “enhance” refers to making something greater in value, beauty or effectiveness, or to increase or intensify in health, quality, value, or power. The term “enhance” also can refer to augmenting, or providing improved, advanced or sophisticated features.

The term “increase” refers to making or becoming greater in size, amount, intensity, or degree.

The phrase “non-naturally occurring water source” as used herein, refers generally to a non-naturally occurring container or vessel, located outdoors, in a natural environment that contains water for drinking purposes. Non-naturally occurring water sources of the invention are placed in the environment and are used to supply water for the animals to consume. In certain embodiments, the non-naturally occurring water sources are located on the ground, or near the ground. In other embodiments, the non-naturally occurring water sources are located above the ground.

The non-naturally occurring water sources of the invention can be containers or wells dug into the ground that are easily for a wild animal to access, reach and consume from. A non-naturally occurring water source can be a simple bucket, a tub, a trough, a holder, a vessel, a container, a reservoir, or any other item or a hole or well carved or dug out of the earth that can retain or hold a volume of water and not leak. The non-naturally occurring water sources of the invention hold water, as well as water mixed with supplements, minerals, attractants, or a combination thereof, or any other element, compound or composition desired. The non-naturally occurring water source can be made of materials such as ceramics, metal, glass, plastic, resin, wood, earthenware, pottery, clay, nylon, or any other material that is sufficiently able to retain the water and has the ability to withstand the environment where it is placed.

The compounds described herein may be present in the nutritional supplements, trace minerals, attractants, or additives for use in the invention. The minerals, elements, stock salts, attractants, supplements and additives may be elements, compositions or compounds, and they may be added to the water in the form of a salt or solvate. For example, in cases where compounds are sufficiently basic or acidic to form stable nontoxic acid or base salts, administration and use of the compounds as salts may be appropriate. Examples of acceptable salts for veterinary, wildlife, wild game or agricultural purposes, which can be used in wildlife populations, are organic acid addition salts formed with acids which form a physiological acceptable anion, for example, tosylate, acetate, citrate, malonate, tartrate, succinate, benzoate, ascorbate, α-ketoglutarate, and α-glycerophosphate. Suitable inorganic salts may also be used, including hydrochloride, halide, sulfate, nitrate, bicarbonate, and carbonate salts.

Veterinary acceptable salts may be obtained using standard procedures well known in the art, for example by reacting a sufficiently basic compound such as an amine with a suitable acid to provide a physiologically acceptable ionic compound. Alkali metal (for example, sodium, potassium or lithium) or alkaline earth metal (for example, calcium) salts of carboxylic acids can also be prepared by analogous methods.

The supplements, minerals, additives, attractants, and nutrients as used in the methods and systems described herein can be the in form of pharmaceutical compositions and administered to a wildlife animal host, such as an ungulate, in a variety of forms. The forms can be specifically adapted to a chosen route of administration, e.g., oral or parenteral administration, by intravenous, intramuscular, topical or subcutaneous routes.

The elements, minerals, trace minerals, stock salts, supplements and nutritional supports may also contain one or more of the following: binders such as gum tragacanth, acacia, corn starch or gelatin; excipients such as dicalcium phosphate; a disintegrating agent such as corn starch, potato starch, alginic acid and the like; and a lubricant such as magnesium stearate. A sweetening agent such as sucrose, fructose, lactose or aspartame; or a flavoring agent such as peppermint, oil of wintergreen, or cherry flavoring, or any other suitable organoleptic compound, may be added.

The methods and systems of the invention may be used for any number of animals. As a non-limiting example, the methods and systems of the invention may be used for one animal or for an entire population or herd of animals on a given property. The supplements, attractants, minerals, and nutritional supports or additives may be administered in the non-naturally occurring water source in a unit dosage form. When the unit dosage form is a capsule, it may contain, in addition to materials of the above type, a liquid carrier, such as a vegetable oil or a polyethylene glycol. Various other materials may be present as coatings or to otherwise modify the physical form of the unit dosage form. For instance, tablets, pills, or capsules may be coated with gelatin, wax, shellac or sugar and the like. A syrup or elixir may contain the active compound, sucrose or fructose as a sweetening agent, methyl and propyl parabens as preservatives, a dye and flavoring such as cherry or orange flavor. Any material used in preparing any unit dosage form can be pharmaceutically acceptable and substantially non-toxic to the animals in the amounts employed. In addition, the active compound may be incorporated into sustained-release preparations and devices.

Solutions of the active compound or its salts can be prepared in water, optionally mixed with a nontoxic surfactant. Dispersions can be prepared in glycerol, liquid polyethylene glycols, triacetin, or mixtures thereof, or in a pharmaceutically or veterinary acceptable oil. Under ordinary conditions of storage and use, preparations may contain a veterinary or agriculturally acceptable preservative to prevent the growth of microorganisms.

The supplements and nutritional supports used in the methods and systems of the invention can be in the form of aqueous solutions, dispersions, or powders comprising the active ingredient adapted for the environmental conditions under which it will be administered. The ultimate dosage form may be fluid and stable under the conditions of manufacture, storage, and environmental use. The liquid carrier or vehicle can be a solvent or liquid dispersion medium comprising, for example, water, ethanol, a polyol (for example, glycerol, propylene glycol, liquid polyethylene glycols, and the like), vegetable oils, nontoxic glyceryl esters, and suitable mixtures thereof. The proper fluidity can be maintained, for example, by the formation of liposomes, by the maintenance of the required particle size in the case of dispersions, or by the use of surfactants. The prevention of the action of microorganisms can be brought about by various veterinary and agriculturally safe for consumption antibacterial and antifungal agents. In many cases, it will be preferable to include isotonic agents, for example, sugars, buffers, or sodium chloride.

Useful solid carriers include finely divided solids such as talc, clay, microcrystalline cellulose, silica, alumina, and the like. Useful liquid carriers include water, dimethyl sulfoxide (DMSO), alcohols, glycols, or water-alcohol/glycol blends, in which a compound can be dissolved or dispersed at effective levels, optionally with the aid of non-toxic surfactants. Adjuvants such as fragrances and additional antimicrobial agents can be added to optimize the properties for a given use. The resultant liquid compositions can be applied from absorbent pads, used to impregnate bandages and other dressings, or sprayed onto the affected area using a pump-type or aerosol sprayer.

Thickeners such as synthetic polymers, fatty acids, fatty acid salts and esters, fatty alcohols, modified celluloses, or modified mineral materials can also be employed with liquid carriers to form spreadable pastes, gels, ointments, soaps, and the like, for application directly to the skin or mucous membranes of the animal.

The amount of a compound, or an active salt or derivative thereof, required for use in treatment or nutritional augmentation will vary not only with the particular compound or salt selected but also with the following non-limiting examples: the route of administration, the nature of the condition being treated or the nutritional requirement being supported, and the age and condition of the animal or animal population, the location, the estimated population size, and/or the ecosystem. The amount of a compound, attractant, supplement or other desired substance to be used in the methods provided herein will be ultimately at the discretion of the user.

The supplement, compound, composition, nutrient, attractant, or other desired substance to be used in the methods and systems provided herein can be conveniently administered in a unit dosage form or in bulk. If administered in a unit dosage form, as a non-limiting example, may contain 5 to 1000 mg/m², conveniently 10 to 750 mg/m², most conveniently, 50 to 500 mg/m² of active ingredient per unit dosage form. In certain embodiments, the desired dose is calculated based on the number of animals in a particular area to be given the supplement, such as the size of a herd on a property or in a given area of a property. In some embodiments, the desired dose per animal per day or per week is then multiplied by the number of animals in a herd or population, and the proper amount is mixed or added to the proper amount of water and the water containing the substance is then placed in the non-naturally occurring water source and placed in the animals' environment. In some embodiments, the desired dose for the animal population is from about 0.5 grams to about 500 grams. Optionally, the desired dose for 5 days is from about 0.1 grams to about 1000 grams of a solid or granular substance in 25 gallons of water. As a non-limiting example, the desired dose of stock salts for a population of deer is approximately 150-250 grams of stock salts in 25 gallons of water. In another non-limiting example, the desired dose for a population of deer is approximately 150-300 grams of stock salts and 150-600 grams trace minerals in 25 gallons of water. In certain embodiments, trace minerals are added to the water in the non-naturally occurring water source in an amount that is twice the amount of stock salts added to the water in the non-naturally occurring water source. In certain embodiments, the dose of 2 parts trace minerals to 1 part stock salts in 25 gallons of water is the desired dose for a population of deer for a 5 day period. The doses of proteins and other supplements can be calculated based on desired outcome, size of herd, needs of the herd, traits of the animals to be enhanced, or for any other reason, and the doses may easily be calculated by one of ordinary skill in the art.

The desired dose may conveniently be presented in a single dose or as divided doses administered at appropriate intervals, as a non-limiting example, as two, three, four or more sub-doses per day, per month, or per year. The sub-dose itself may be further divided, e.g., into a number of discrete loosely spaced administrations.

In an embodiment, the systems and kits of the invention may contain one or more reservoirs for holding water in the outdoors, and one or more containers of a pre-mixed solution, with directions for use and labels. The pre-mixed solutions can be solutions containing an effective amount of a nutrient, supplement, or additive, or an effective amount of stock salts or trace minerals, or a combination thereof, to confer a desired benefit on the animal or animals being treated. The water reservoir or reservoirs could then be placed in the desired setting and filled with the pre-mixed solution. Alternatively, the pre-mixed solution can be a concentrate, where an amount of the concentrate is mixed with a defined amount of water in order to arrive at the desired effective concentration. Additionally, instead of a pre-mixed solution, the nutrient, supplement, additive, or stock salts or trace minerals can be in the form of a solid, such as a tablet, powder, granule or any other solid form. An appropriate amount of the solid form of the nutrient, supplement, additive, or stock salts or trace minerals can be dispensed and mixed with water to create a solution for use in the methods and systems of the invention.

The kits of the invention may contain one or more reservoirs for holding water in the outdoors, along with an amount of the nutrients, supplements, or additives, or an amount of stock salts or trace minerals, or a combination thereof, in liquid, gel, emulsion, powder, solid, granule, tablet or other form, and with directions for use and labels.

Applicants have made the surprising discovery, based on research and observation that attributes or traits of an animal or animals, including but not limited to wildlife animals, may be enhanced by the placement of a non-naturally occurring water source in the animals' environment, where the non-naturally occurring water source not only provides a source of hydration for the animals, but also provides beneficial water-soluble additives or supplements for the animals' diet or health. The beneficial additives and supplements in the water source can be selected for addition to the water based on the desired outcomes for an animal population in a given region.

Through the use of non-native or non-naturally occurring water sources, additives or supplements can be dissolved or mixed into the water and in this way, the non-naturally occurring water sources provide a delivery vehicle for the supplements or additives of interest. The non-naturally occurring water source can also be used in combination with one or more attractants, depending on the desired outcome or needs of the population.

As provided by the invention, the non-naturally occurring water source may be available for an animal or animal population or in a given area on a 24-hour basis, as well as at pre-selected times within a 24-hour period, or at pre-selected times or days within a month, season, or other time period or time increment, depending on the needs of the animal population or the outcome desired.

The non-naturally occurring water source or container serves as a source of water, and consists of, but is not limited to, for example, a simple bucket, trough, tank, tote, basin, drum or any type of feeder or agriculture tank. The non-naturally occurring water source may also be a depression in the ground that contains a tank or other type of vessel (see examples above) or may be lined with a plastic or other waterproof lining, so as to be able to retain the water for a duration of time. The non-naturally occurring water source or container can also be, for example, a designed and constructed water source for a particular animal, environment, or volume, or any type of container that can hold an amount of water and be accessible to the wildlife for drinking purposes. Applicants have found that once the non-naturally occurring water source is placed into the environment, animals and wildlife will utilize the non-naturally occurring water source, even if naturally occurring water sources are located nearby. Applicants have discovered that the non-naturally occurring water source or container containing water will bring one or more animals of a population back to an area or ecosystem previously abandoned by said animal population. The non-naturally occurring water source may be located above ground, on the ground or in the ground, depending on the need of the animals to be treated, the desired outcomes, or for any other reason.

Various supplements, nutrients and additives are available that can enhance the water source and therefore benefit land management and wildlife management similar to that available today and used today in solid form. As non-limiting examples, the supplement or additive may consist of one or more of the following: protein, calcium, salts, minerals, trace minerals, other minerals, mineral supplements, nutrients, vitamins, medications, pharmaceuticals, vaccines, neutraceuticals, medical treatments, food additives, nutritional supplements, medicaments, hormones, antibiotics, insecticides, antivirals, and antihelmintics for animals with ruminant or non-ruminant digestive systems. The supplements, systems, compositions and methods of the invention may or may not be used in conjunction with other treatments or feeding regimes for an animal population.

The additives and supplements can be in any form that allows for effective distribution in the non-naturally occurring water source. Such additives and supplements can be in the form of a powder, a salt, a solid, a water-soluble solid, a solution, an emulsion, a liquid, and may be water soluble or capable of dissolving in an aqueous material. The supplements used in the invention may be in a concentrated form, such that when an amount of the supplement is added to the water and dispensed in the non-naturally occurring water source, the appropriate dose of supplement is delivered to the animal upon consumption by the animal.

In certain wild animal or wild life habitats, animals may be drawn or lured to a particular area by the use of one or more “attractants,” including but not limited to foods or consumable substances, including but not limited to, acorns or acorn-containing mixtures, grain or mixtures of grains, apples or apple-containing mixtures, mineral mixtures, molasses or other sugars or mixtures of sugars, starches, ciders, nuts or nut butters, including but not limited to peanut butter, and salts. Attractants are readily commercially available or can be made to order. Attractants also can be food plots or agricultural plantings that are naturally appealing to wildlife and wild animals. Attractants are readily commercially available.

The use of a non-naturally occurring water source as a water delivery system has many benefits, including as an attractant, as well as a nutrition delivery system. The use of a non-naturally occurring water source as a water delivery system also provides increased diet consumption in an animal or animal population that becomes habit forming for deer and wildlife, providing advantages for deer hunters and wildlife managers.

Non-naturally occurring water sources were placed in undeveloped environments, on the ground, outdoors. These environments contained populations of free ranging deer. During different experiments conducted by Applicants, the non-naturally occurring water sources contained water only, water with stock salts solutions, and water with a combination of stock salts and trace minerals. In the experiments, Applicants discovered that the deer populations preferred the non-naturally occurring water sources that contained water with stock salts and water with a combination of stock salts and trace minerals over water only. Applicants also found that the deer populations did not prefer the combination of stock salts and trace minerals over stock salts only solutions. It is known that protein and other nutrients are beneficial to the health and wellbeing of deer in the wild. It is also known that it is difficult to get deer living in the wild to consume protein or other beneficial nutrients. When stock salts are added to water in a non-naturally occurring water source, deer will be attracted to the non-naturally occurring water source; deer will drink from the non-naturally occurring water source. Applicants have discovered that deer prefer to consume from the non-naturally occurring water source versus a solid feeder. Thus, Applicants have provided improved methods and systems for not only attracting but nourishing and treating deer populations in the wild. Applicants have devised systems and methods to provide nourishment to a deer population, by providing a non-naturally occurring water source that contains not only stock salts, but also protein or other nutritionally beneficial components for the deer population.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

Experiments were conducted to assess the use of a non-naturally occurring water source (a water trough) by wildlife in an environment where a naturally occurring source of water was nearby.

### Example 1

Determining whether or not deer would use a newly placed, non-naturally occurring water source when naturally occurring water was readily available in a running creek only 100 yards away.

Method: The experiment was done at an outdoor environment, on an undeveloped property that contained a population of free ranging deer. For a non-naturally occurring water source, a water trough was used and was placed on the ground and filled with water. The water trough was located approximately 100 yards from a naturally-occurring creek with running water. Water in the trough was replenished approximately every 5 days. A camera (Wildgame Camera, selected from models X6c, Elite 8 and W48) was placed 10 feet from the water trough, in a location that provided two pictures when triggered by movement. The camera took two pictures every minute while movement was detected. The camera was operable 24 hours a day; 7 days a week, and therefore, it captured all use of the water trough.

Results: Deer appeared on trail camera drinking from the water trough the first evening. Deer activity was observed daily, and many deer used the trough multiple times throughout a 24 hour period. All antlered and/or identifiable deer on the property used the water trough by the end of the first week, and frequented the water trough ongoing.

Discussion: The water trough placed in the environment for this experiment was used by the deer in the region daily for water consumption, and sometimes it was used by deer for water consumption multiple times in one day.

### Example 2

Determining whether or not the deer in a particular environment that consume corn and solid wildlife feed supplements will also utilize a water trough located just 100 yards away.

Method: The experiment was done at an outdoor environment, on an undeveloped property that contained a population of free ranging deer. A camera (Wildgame Camera, selected from models X6c, Elite 8 and W48) was placed 10 feet from a wildlife feeder. The camera was situated in a location that provided two pictures when triggered by movement. The camera took two pictures every minute while movement was detected. The camera was operable 24 hours a day; 7 days a week, and therefore, it captured all use of the feeder. The camera was placed on a trail immediately prior to the placement of the wildlife feeder. The feeder was filled with corn and wildlife feed supplements. Deer regularly visited the feeder and consumed the feed, as documented by the photos from the trail camera. The feed was replenished regularly. The deer population was observed (via trail camera photos) using the feeder for 6 months. After 6 months, a non-naturally occurring water source—a water trough—was placed on the ground and filled with water. The water trough was placed 100 yards from the established feeder with corn and wildlife feed supplements. A camera (Wildgame Camera selected from models X6c, Elite 8 and W48) was located 10 feet from the water trough, in a location that provided two pictures when triggered by movement. The camera took two pictures every minute while movement was detected. The camera was operable 24 hours a day; 7 days a week, and therefore, it captured all use of the water trough.

After a defined time increment, the experiment was repeated in different locations on the property. The same procedures were used in the repeat experiments—that is, the feeder was established 6 months prior to the placement of the water trough. In repeat experiments, the distance between the water trough and the feeder remained constant. This protocol was repeated over several months and is ongoing.

Results: Deer appeared on the trail camera the same day as the day the water trough was placed. Per photographs taken by trail camera, the deer came into view in the trail camera following the placement of the water trough at a rate that was four times greater than that obtained on the trail camera when only the corn feeder and wildlife feed supplements were provided. Some deer used both the feeder and the water trough. However, numerous identifiable deer utilized the water trough but did not use the feeder and wildlife supplements. It was also observed via trail camera that deer remained in the immediate vicinity of the water trough for longer periods of time than when only the corn feeder and wildlife feed supplements were provided.

### Example 3

Determining the response of deer when a non-naturally occurring water source is placed in area where a creek previously ran with water, but is now dry from drought conditions. Specifically, determining whether a non-naturally occurring water source kept deer on a property when no other water source was available.

Methods: The experiment was done at an outdoor environment, on an undeveloped property that contained a population of free ranging deer. The property previously had a source of naturally occurring water that the deer had utilized; however, due to drought conditions, the creek was dry. Cameras were placed on a trail and documented the visits to the area by wildlife, as in Examples 1 and 2.

The non-naturally occurring water source (a water trough) was filled with water and placed on the ground about 100 yards from established feeder with corn and wildlife feed supplements. The feed in the feeder and the water in the trough were replenished regularly, approximately every 5 days. The water trough also was situated approximately 100 yards from a dry, naturally-occurring creek bed. The camera (Wildgame Camera, selected from models X6c, Elite 8 and W48) was placed 10 feet from the water trough, in a location that provided two pictures when triggered by movement. The camera took two pictures every minute while movement was detected. The camera was operable 24 hours a day; 7 days a week, and therefore, it captured all use of the water trough.

Results: Deer were observed via the trail camera using the feeder and eating the feed placed in the feeder. An identifiable group of deer appeared on the trail camera and daily utilized the water trough. In addition, numerous other game animals used the water trough throughout the months it was maintained on the property, as it was the sole resource for water within a certain geographic location. All identifiable deer appeared daily with no deer missing from the trail camera photos.

Summary: The non-naturally occurring water source allowed the property to maintain the deer population throughout the drought period, without the deer leaving the geographical area in search of other water sources.

### Example 4

Determining whether or not the addition of certain supplements to the water trough would affect or alter the use of the trough by the deer population.

Methods: The experiment was done at an outdoor environment, on an undeveloped property that contained a population of free ranging deer. A non-naturally occurring water source (a water trough) was filled with water, and placed on the ground in an environment where the deer population resided. The water in the trough was replenished regularly, approximately every 5 days. A trail camera documented the deer consuming water at the water trough. The camera documented the regular and consistent use of the water trough by the deer population, as described in previous examples.

After 3 months of having the non-naturally occurring water source in the environment, sweet flavors known for their attractiveness to deer were added to the water in the trough. At the same time, nutritional supplements known to be beneficial to deer were also added to the water in the water trough.

Results: Via photos taken by the trail camera, deer were observed using the water trough throughout the experiment. However, the deer not only continued their use of the water trough once the supplements were added, but did so at a rate that was 10 times greater than when the water trough contained water only. In addition, numerous deer that had not been seen via trail camera monitoring of the water trough appeared for the first time following the addition of the supplements and attractants to the water. It was noted that the length of time the deer stayed per visit at the water trough increased following the addition of the supplements and attractants, and the consumption of water increased at a rate that was three times greater than when the water trough contained only water.

Conclusion: The use of a non-naturally occurring water source or watering system on a given property with attractants and nutritional supplements will increase the holding capacity of the property and ability of the property to hold a deer population. Deer will also frequent a non-naturally occurring water source or watering system more frequently they will frequent a corn feeder or feed supplement in close proximity. The deer utilized the non-naturally occurring water source or watering system with attractants and nutritional supplements through convenience even when naturally occurring water is readily available on the property. When using a non-naturally occurring water source or a watering system as a means to deliver nutrients, vitamins, elements, stock salts, supplements and/or attractants, the use of a non-naturally occurring water source or watering system and water as a delivery method for supplements and attractants is an effective way for land/deer managers to deliver beneficial substances to the deer herd. It is also more effective and cost beneficial than use of traditional edible feed supplements and food sources.

### Example 5

Determining the effect of supplying a deer population with stock salt and trace minerals in non-naturally occurring water sources.

Methods: The experiment was performed in two different, undeveloped outdoor properties. One property was approximately 40 acres in size, and the other property was approximately 90 acres in size. Each property contained a population of free ranging deer. On each property, six sources of non-naturally occurring water, in the form of 40 gallon plastic tanks, were filled with water and placed on the ground approximately 200-300 yards apart from each other. Each bucket was placed on the ground within 100 years of a naturally occurring source of water. The water in each tank was replenished regularly, approximately every 5 days.

Three tanks were filled with only pure water, and served as the controls. These tanks were refilled with water throughout the duration of the experiment, which was done over several months. The remaining three tanks were the experimental tanks. The experimental tanks were filled with water containing various concentrations of stock salt and trace minerals. In one experiment, each experimental tank contained 2 cups of trace minerals and 1 cup of stock salt in 25 gallons of water. These tanks were refilled with the respective concentrations of stock salt and trace minerals in water throughout the duration of the experiment, which was done over several months.

A trail camera documented the deer consuming water at each tank. The camera documented the regular and consistent use of the tanks by the deer population, as described in previous examples.

Results: As documented by the trail camera photos, the deer utilized both the water only (control) tanks and the tanks containing water with various concentrations of stock salts and trace minerals. The deer population frequented the experimental tanks containing the water with stock salts and trace minerals more frequently than the control water tanks. No negative effect on consumption was observed due to the stock salts and trace minerals in the water. In fact, an overall increase in usage by the deer population was observed in the tanks containing water with stock salts and trace minerals over the control tanks with plain water.

### Example 6

Determining the effect of a non-naturally occurring water source in close proximity to an established mineral lick.

Methods: The experiment was performed in two different, undeveloped outdoor properties. One property was approximately 40 acres in size, and the other property was approximately 90 acres in size. Each property contained a population of free ranging deer.

Each property contained several sites where established, regularly maintained and replenished mineral licks were located on the ground and were utilized by the deer population. Non-naturally occurring water sources, in this case plastic tanks, containing water with various concentrations of stock salts and trace minerals were placed on the ground, within several feet of the established mineral licks on the ground.

A trail camera documented the deer consuming water at the non-naturally occurring water sources. The camera documented the regular and consistent use of the water tanks by the deer population, as described in previous examples.

Results: The deer population abandoned the mineral licks upon the introduction of the tanks containing the water with various concentrations of stock salts and trace minerals. The deer consumed the water containing various concentrations of stock salts and trace minerals daily, and sometimes several times per day, for the duration of the experiment.

### Example 7

Determining the usage of the non-naturally occurring water sources in cold temperatures.

Methods: The experiment was performed in two different, undeveloped outdoor properties. One property was approximately 40 acres in size, and the other property was approximately 90 acres in size. Each property contained a population of free ranging deer.

Six non-naturally occurring water sources, in this case plastic tanks, were placed on the ground, within several feet of the established mineral licks on the ground.

A trail camera documented the deer consuming water at the non-naturally occurring water sources. The camera documented the regular and consistent use of the water tanks by the deer population, as described in previous examples.

As the temperatures on the property decreased in the fall, various concentrations of stock salts were added to the water in the 3 of the tanks for the purpose of lowering the freezing point of the water in the tanks. The remaining 3 tanks continued to contain water only, and served as the controls.

Results: Due to the addition of the stock salts, the water in the tanks containing the stock salts remained liquid whereas the tanks containing only water froze. The deer population abandoned the frozen tanks (which contained only water), and continued to drink from the tanks containing the stock salts solutions.

As the temperatures on the property became still colder, the water in the tanks containing the stock salts solutions became semi-frozen or slushy, yet the deer still frequented the tanks and drank from the tanks. Once the water in the tanks containing the stock salts solutions froze solid, the deer still frequented the buckets containing the stock salts solutions daily and licked the ice block to get salt and mineral. In fact, the photos on the wild game cameras increased significantly in the fall/winter months at the stock salt solution tanks. In addition, the photos increased even when the stock salts solutions in the tanks turned to slush or ice. Even when the ice in the tanks containing frozen stock salts solutions was covered with snow, the deer were observed in the wild game cameras using their noses to push and clear the snow to access the ice block and lick at the frozen block of stock salts solutions.

Applicants have observed that a population of deer will utilize a non-natural water source throughout the 12 month calendar. Further, the use of the non-natural water source by the deer population becomes habit forming, as the deer visit the water source almost daily, daily or more than once per day.

### Example 8

### Placement of a Water Source Near Protein Feeder

Methods: The experiment was performed in two different, undeveloped outdoor properties. One property was approximately 40 acres in size, and the other property was approximately 90 acres in size. Each property contained a population of free ranging deer.

Twelve non-naturally occurring water sources, in this case plastic tanks, containing water with various concentrations of stock salts were placed on the ground, within several feet of the established mineral licks on the ground. Six of the tanks contained various concentrations of stock salts in the water. The remaining six tanks contained water only, and served as the controls.

One control tank and one experimental tank were placed on the property approximately 5 to 10 feet from an established wildlife protein feeder. In a different area, one control tank and one experimental tank were placed on the property, but were located approximately 30 feet from a protein feeder. This experimental set-up was repeated in two additional locations on the property, using the remaining the eight control and experimental tanks.

The deer population was observed via wild game camera at each location, as described in previous examples. A trail camera documented the deer consuming water at the non-naturally occurring water sources. The camera documented the regular and consistent use of the water tanks by the deer population, as described in previous examples.

Results: When the non-naturally occurring water source was located approximately 5-10 feet from the feeder, the amount of protein consumed by the deer at the feeder increased versus when the non-naturally occurring water source was located 30 feet away from the protein feeder.

Additionally, deer remained near the feeder for longer periods of time, and consumed higher amounts of protein, when the non-naturally occurring water source was placed near the protein feeder. This allows game managers to get the targeted amount of protein or nutrients to a deer population. The deer consume more of their daily dietary protein requirements when a non-naturally occurring water source is located approximately 5-10 feet from a protein source or protein feeder.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

What is claimed is:

1. A method of enhancing one or more traits of an animal in the wild, comprising providing a non-naturally occurring water source in a natural environment, wherein said water source contains water and an effective amount of a supplement, where the environment contains an animal, and wherein the animal drinks an amount of the contents of said water source, and the ingestion of the contents of the water source by the animal provides one or more traits of said animal to be enhanced, in comparison to an animal not drinking an amount of the contents of said water source.

2. The method of claim 1, wherein the animal is a wild animal.

3. The method of claim 2, wherein the wild animal is an ungulate.

4. The method of claim 3, wherein the ungulate is a deer, elk, caribou or moose.

5. The method of claim 1, wherein the supplement is an attractant, a nutrient, a nutritional supplement, stock salts, or trace minerals, or a combination thereof.

7. The method of claim 3, wherein the trait of that is enhanced is the antler size.

8. The method of claim 7, wherein the size of the antlers of said ungulate is increased, as compared to the size of the antlers of an ungulate not consuming the supplemented water in the water source.

9. A system for increasing the intake of nutrients by an animal in the wild, comprising placing a non-naturally occurring water source in an environment, wherein the environment contains at least one animal, wherein said water source contains water and an effective amount of a beneficial nutrient for the animal, wherein the animal is attracted to the water source, and wherein the animal consumes an amount of the contents of the water source, wherein by consuming the contents of the water source, the animal consumes an amount of a nutrient, as compared to an animal not consuming the contents of the water source.

10. The system of claim 9, wherein the nutrient is a protein.

11. The system of claim 10, further comprising an amount of stock salts, one or more trace minerals, vitamins, elements, or a combination thereof.

12. The system of claim 9, further comprising an amount of an attractant.

13. The system of claim 9, wherein the animal is an ungulate.

14. The system of claim 13, wherein the ungulate is a deer, elk, caribou or moose.

15. A method of enhancing the health of a wildlife animal population, comprising placing a non-naturally occurring water source in an environment, wherein the environment contains a population of animals, wherein said water source contains water and an effective amount of a supplement for the animals, wherein the animals are attracted to the water source, and wherein the animals consume an amount of the contents of the water source, wherein by consuming the contents of the water source, the animals consume an effective amount of a supplement, which enhances the health of the animal population, as compared to an animal not consuming the contents of the water source.

16. The method of claim 15, wherein the supplement is one or more proteins, vitamins, trace elements, trace minerals, salts, sugars, enzymes, pharmaceuticals, additives, attractants, amino acids, vaccines, anti-oxidants, DNA, RNA, neutraceuticals, medicaments, or a combination thereof.

17. A method of administering at least one supplement to an animal, comprising placing a non-naturally occurring water source in said animal's environment, wherein the water source contains water and an effective amount of at least one supplement, wherein the supplement is consumed by the animal when the animal consumes the water from the water source.

18. The method of claim 17, wherein the animal is an ungulate.

19. The method of claim 17, wherein the supplement is a vitamins, a mineral, a trace mineral, a salt, a sugar, an enzyme, an attractant, a protein, or a combination thereof.

20. A method of increasing the protein intake of an animal, comprising placing a non-naturally occurring water source in said animal's environment, wherein the water source contains water and an effective amount of stock salts and effective amount of a protein source wherein the animal is attracted to the water source and when the animal consumes the water, the animal consumes the protein source.
